(19) United States
(12) Patent Application Publication
(10) Pub. No.: US 2013/0103550 A1
(43) Pub. Date: Apr. 25, 2013

(54) DISCOVERY OF DIGITAL GOODS IN AN ONLINE MARKETPLACE

(71) Applicants: Carl Patrick Nygaard, Sunnyvale, CA (US); Ori Gershony, Redmond, WA (US); Stephane Doyon, Quebec (CA); Timothy Classen Hesterberg, Seattle, WA (US); Pierre-Antoine Manzagol, Montreal (CA)

(72) Inventors: Carl Patrick Nygaard, Sunnyvale, CA (US); Ori Gershony, Redmond, WA (US); Stephane Doyon, Quebec (CA); Timothy Classen Hesterberg, Seattle, WA (US); Pierre-Antoine Manzagol, Montreal (CA)

(21) Appl. No.: 13/654,766

(22) Filed: Oct. 18, 2012

Related U.S. Application Data
(60) Provisional application No. 61/550,877, filed on Oct. 24, 2011.

(51) Int. Cl. G06Q 30/00

(52) U.S. Cl. 705/27.1

(57) ABSTRACT

A method of presenting to a user a subset of digital goods that may be executed by a computing device is disclosed, where the subset of applications is selected from a plurality of digital goods available in an online marketplace for such digital goods. The method includes ranking the digital goods based on at least one signal, statistically sampling the ranked digital goods based on their rankings, where higher-ranked digital goods are favored over lower-ranked digital goods in the statistical sampling, and presenting the statistically sampled digital goods in the online marketplace to the user in an order based on the statistical sampling, where at least one lower-ranked digital good is presented before a higher-ranked digital good.

### CROSS-REFERENCE TO RELATED APPLICATIONS

This application claims priority to and the benefit of U.S. Provisional Application Ser. No. 61/550,877, entitled “DISCOVERY OF DIGITAL GOODS IN AN ONLINE MARKETPLACE,” filed on Oct. 24, 2011, the disclosure of which is hereby incorporated herein by reference in its entirety.

### TECHNICAL FIELD

This disclosure relates to the discovery of digital goods in an online marketplace.

### BACKGROUND

When digital goods, such as installable applications, are offered in an online marketplace, an overwhelming number of applications may exist in the marketplace and may compete for the attention of users of the marketplace. However, only a few digital goods can be displayed to the user at one time on a user interface of the marketplace that is shown to the user. Thus, there is a need to select the digital goods that are best suited for the user.

However, in addition to satisfying the need of a user to see the goods that are best suited to the user, a provider of the marketplace may also want to present the user may also want to discover goods that he or she may not typically encounter in the marketplace (the so-called “long-tail” of the collection of goods). The provider of the marketplace also may want to provide developers of digital goods with a certain amount of exposure of their digital goods in the marketplace, so that the developers are confident of having an opportunity to present their goods to users of the marketplace. It can be difficult to connect end users with a wide range of the many digital goods available in the marketplace. In particular, benign discovery algorithms, such as stack ranking items by the popularity of each item tends to favor items that are already popular, rather than allowing unpopular and possibly new items from being discovered by users.

### SUMMARY

In a general aspect, a method of presenting to a user a subset of digital goods that may be executed by a computing device is disclosed, where the subset of applications is selected from a plurality of digital goods available in an online marketplace for such digital goods. The method includes ranking the digital goods based on at least one signal, statistically sampling the ranked digital goods based on their rankings, where higher-ranked digital goods are favored over lower-ranked digital goods in the statistical sampling, and presenting the statistically sampled digital goods in the online marketplace to the user in an order based on the statistical sampling, where at least one lower-ranked digital good is presented before a higher-ranked digital good.

In another general aspect, a tangible computer-readable storage medium can have instructions recorded and stored on it that, when executed by one or more processors of a computer system, cause the computer system to: present to a user a subset of digital goods that may be executed by a computing device, the subset of applications being selected from a plurality of digital goods available in an online marketplace for such digital goods; rank the digital goods based on at least one signal; statistically sample the ranked digital goods based on their rankings, wherein higher-ranked digital goods are favored over lower-ranked digital goods in the statistical sampling; and present the statistically sampled digital goods in the online marketplace to the user in an order based on the statistical sampling, wherein at least one lower-ranked digital good is presented before a higher-ranked digital good.

In another general aspect, a system that presents to a user a subset of digital goods that may be executed by a computing device, where the subset of applications is selected from a plurality of digital goods available in an online marketplace for such digital goods, includes one or more memory devices arranged and configured to store executable code, and one or more processors operably coupled to the one or more memory devices. The processors are arranged and configured to execute the code such that the apparatus performs the actions of: ranking the digital goods based on at least one signal; statistically sampling the ranked digital goods based on their rankings, wherein higher-ranked digital goods are favored over lower-ranked digital goods in the statistical sampling; and presenting the statistically sampled digital goods in the online marketplace to the user in an order based on the statistical sampling, wherein at least one lower-ranked digital good is presented before a higher-ranked digital good.

Implementations can include one or more of the following features. For example, statistically sampling the ranked digital goods can include selecting digital goods from the ranked digital goods based on a probability function that changes monotonically between a first endpoint and a second endpoint. The method can further include ranking the digital goods based on a plurality of different signals, each of the different signals defining a different ranking stream, assigning a weight to each ranking stream, selecting digital goods from the different ranking streams for presentation in the online marketplace to the user in proportion to the number weights of the ranking streams, and statistically sampling the ranked digital goods in the different ranking streams based on the rankings of the digital goods in the stream, wherein higher-ranked digital goods are favored over lower-ranked digital goods in the statistical sampling.

The subset of digital goods can include web applications that are installable for use in a web browser. The at least one signal can include a signal that is based on a response time of the web application while being executed by a computing device. The at least one signal can include a signal that is based on information received from one or more browsers that previously executed the digital good. The at least one signal can include a signal that is based on at least one digital good performance metric. The digital good performance metric can be based on a rate at which the digital good crashes while being executed by a computing device. The digital good performance metric based on a rate at which the digital good crashes can be determined based on information received from browsers that execute the digital good.

The at least one signal can include a signal that is based on how often a digital good is used after it is downloaded from the marketplace. The method can further include receiving information from a plurality of client devices about how often the digital good is front-facing within a user interface of the client device for executing the digital good, and generating the signal that is based on how often a digital good is used after it is downloaded from the marketplace based on the received information. The method can further include receiving information from a plurality of client devices about how often the digital good is launched within a user interface of the client device for executing the digital good, and generating the signal that is based on how often a digital good is used after it is downloaded from the marketplace based on the received information. The method can further include receiving information from a plurality of client devices about how often the digital good is open within a user interface of the client device for executing the digital good, and generating the signal that is based on how often a digital good is used after it is downloaded from the marketplace on the received information.

The at least one signal can include a signal that is based on recent trends in query terms, related searches, and results received through a search engine. The at least one signal can include a signal that is based on how often a digital good is recommended by a user of the digital good to acquaintances in social networks of the user. The ranking of the digital goods can be specific to a user, and the at least one signal can include a signal that is based on how often a digital good is used by acquaintances in social networks of the user. The ranking of the digital goods can be specific to a user, and the at least one signal can include a signal that is based on how often a digital good is used by acquaintances in social networks of the user. Signals used for ranking goods can include a signal that is based on the preferences of people who have similar preferences and choices as the user.

The ranking of the digital goods can be specific to a user, and the method can further include associating metadata with digital goods of the plurality of digital goods, comparing the metadata associated with digital goods with information associated with the user, and ranking the digital goods based on the comparisons. The information associated with the user can include information generated by the user, including information actively provided by a user and information inferred from user actions.

### BRIEF DESCRIPTION OF THE DRAWINGS

FIG. 1 is a screenshot of the user interface to a marketplace of digital goods.

FIG. 2 is a schematic diagram of a system for ranking digital goods in a marketplace.

FIG. 3 is another screenshot of a user interface to a marketplace of digital goods.

FIG. 4 is another screenshot of a user interface to a marketplace of digital goods.

FIG. 5 is a flowchart of a process for making digital goods in a marketplace.

FIG. 6 is a screenshot of another user interface to a marketplace of digital goods that may be used in another implementation.

FIG. 7 is a plot of an example function that may be used to select items from a ranked list according to a probability that depends on the function.

FIG. 8 is a schematic diagram of a computer system that can be usefor ranking digital goods in a marketplace.

### DETAILED DESCRIPTION

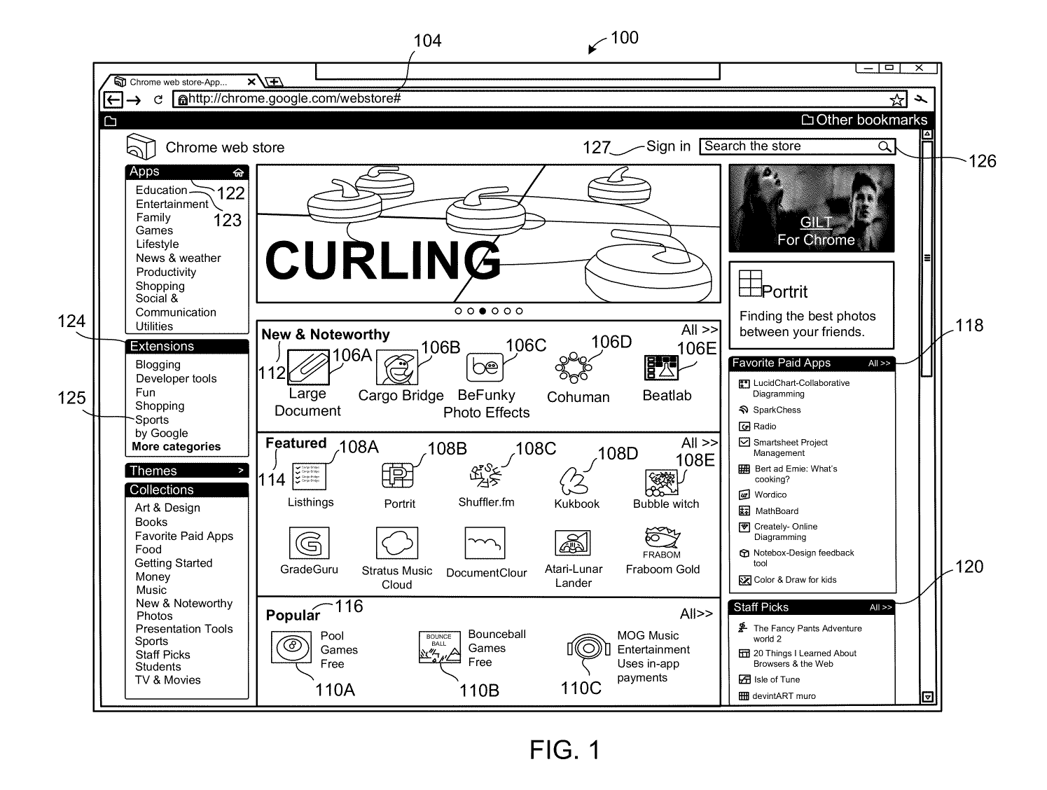

FIG. 1 is a screenshot of a user interface 100 to a marketplace of digital goods. The user interface 100 can be displayed by a browser application that is executed by a computing device that may be connected to a network (e.g., the Internet). The browser application can open one or more tabs 102, one of which may display the user interface to the marketplace when a user navigates to a webpage identified by a uniform resource locator (URL) that provides content to the browser so that the browser can display the user interface to the marketplace in the tab.

The content provided by the webpage to the user can include a plurality of icons 106A, 106B, 106C, 106D, 106E, 106F, 108A, 108B, 108C, 108D, 108E, 110A, 110B, 110C that represent digital goods that can be downloaded from the webpage by the user for execution by a computing device controlled by the user. In some implementations, the digital goods can include any software or executable code (e.g., a desktop software program, a native application, a digital media file, such as a song or a movie, etc. In some implementations, the digital goods can include web applications and browser extensions that can be downloaded from the marketplace to a client computing device where they can be installed on the computing device for execution by a web browser running on the computing device. In this context, a “web application” may be configured to perform a single task or multiple tasks for a user. In such an implementation, the web application may be configured to be executed or interpreted by the web browser. This is compared with native applications that include machine executable code and are configured to be executed directly by a processor or via the operating system of the client device, whereas a web application may be incapable of execution or display without the aid of the web browser. Thus, web applications can be run inside a browser with a dedicated user interface, and typically provide functionality and an experience that is more rich and interactive than a standalone website but less cumbersome and monolithic than a desktop application. Examples of web applications include games, photo editors, and video players that are run inside the browser.

Web applications can be “hosted applications” or “installable applications” (also known as “packaged applications”). Hosted applications may include at least a portion of a web site that itself includes web pages, plus some metadata that may be especially pertinent to the web application or to the user of the web application to allow the web application to perform some particular functionality for the user. Installable applications can be thought of as web applications whose code is bundled, so that the user can download all of the content of the web application for execution by the browser. An installable web application may not need to have network access to perform its functionality for the user, and rather may be executed successfully by the browser locally on the computing device without access to a network. Installable web applications have the option of using Extension APIs, allowing packaged applications to change the way the browser behaves or looks.

In various implementations, the web browser may include or be configured to interact with one or more browser extensions. In this context, a “browser extension” may include one or more web pages packaged or grouped together as a definable whole, and configured to extend the functionality to the web browser. Thus, extensions also provide extra functionality to a browser, but generally, unlike applications, there is little or no user interface component to the functionality provided by an extension. Instead, web extensions extend the functionality of the browser and the websites being viewed in it. For example, web extensions can extend the functionality of the browser by adding a new button to the address bar, such as an ever-present currency converter. Buttons like this can also apply to the current website being viewed—for example, clicking the currency converter button can convert all prices on the website presented to a user into a currency chosen by the user. In another example, an extension can be installed so that when a user hovers a cursor over a thumbnail image on a webpage executed by a browser a larger-size version of the image is displayed until the user moves the cursor away from the image. In another example, and extension may be installed to embed a “mail this” button next to every link in every page. Compared to web applications, extensions cut across websites and web applications. Extensions are usually in effect across all websites (though some are site-specific). Web applications do not combine with other applications in this way. Rather, web applications run standalone, like any regular website.

When installable web applications are “installed” by the user, the web applications may be added to and integrated with the user's web browser. Installation can include adding a shortcut to an application launcher area of the browser. An installation also allows web applications to obtain increased privileges without having to prompt the user for each one individually. Special user interface treatments may apply for the web application's tabs or windows. “Installing” a web application may include integration with: a client's operating system's task and window managers for easy window switching, a taskbar or quick-launch system, interoperating system notification(s), or persistently running background processes. Uninstallation allows for easy removal or deactivation of an installed application from the user's browser or system, and may include revoking all associated privileges. A server-side flag can be used to disable applications remotely.

Browser extensions and web applications can be created for installation in and execution by a browser running on a client computing device. Users who download browser extensions and web applications may get additional functionality for browser extensions and web applications that are installed from a trusted location, such as a trusted digital marketplace. Additional functionality may also be included for a web application that has a trusted company or a trusted developer as the author of the web application.

Within the user interface 100, the installable web applications can be displayed in a manner that is organized to help a user decide which applications may be useful or relevant to the user. For example, the user interface 100 can include a category 112 of applications 106A, 106B, 106C, 106D, 106E, 106F that have been recently released in the marketplace and which a curator of the marketplace may deem to be especially noteworthy to users. In one implementation, the applications 106A, 106B, 106C, 106D, 106E, 106F shown in the category 112 can be limited to applications that have been released in the marketplace within a recent period of time (e.g. one week, one month, three months, six months). Then, a subset of the applications that have been released into the marketplace within the recent period of time can be selected based on a variety of signals that indicate the noteworthiness of the selected applications to the user, and the selected subset of applications 106A, 106B, 106C, 106D, 106E, 106F can be displayed within the category 112. That is, the applications 106A, 106B, 106C, 106D, 106E, 106F shown in the New and Noteworthy category 112 of the user interface 100 can be a subset of a larger number of applications that also could qualify as being new and noteworthy but which have not been selected for display in the user interface 100. A variety of signals that can be used to rank and select the subset of applications as described in more detail below.

In another example, the user interface 100 can include a category 114 of applications 108A, 108B, 108C, 108D, 108E that have been selected to be featured for display in the user interface 100. The applications 108A, 108B, 108C, 108D, 108E that are selected to be featured in the category 114 can be selected based on criteria evaluated by a curator of the market place. For example, the curator may select the applications 108A, 108B, 108C, 108D, 108E for display in the category 114 from a much larger set of applications based on the curator's opinion of the quality, popularity, or utility of the selected applications. In another implementation, the curator may select the applications 108A, 108B, 108C, 108D, 108E based upon payments made by developers of the applications in return for prominent display of the applications in the user interface 100.

In another example, the user interface 100 can include a category 116 of applications 110A, 110B, 110C that have been selected for display in the category 116 of the user interface 100 based on a popularity ranking of the selected applications relative to other applications. The popularity ranking can be determined based on reviews of the applications by users who have downloaded and used the applications. For example, the marketplace may request that users rate applications quantitatively using a system of one to five stars, where five stars is the highest rating, and one star is the lowest rating. Then, applications within the marketplace can be ranked based on their user rating. In one implementation, applications with the highest average rating can be ranked highest. In another implementation, applications with the highest number of five-star ratings can be ranked highest. Then, applications 110A, 110B, 110C with the highest rankings can be selected for display in the user interface 100 of the marketplace.

The user interface 100 of the marketplace also can include categories of applications in other subportions of the user interface 100 in which smaller icons are used to represent the applications that are used in categories 112, 114, 116. For example, category 118 can display “Favorite Paid Apps,” which can be applications for which a user must pay money before being able to download and install the application on the user's computing device. Applications listed in the Favorite Paid Apps category 118 can be the most frequently downloaded and/or most frequently installed applications for which the user must pay money. In another example, category 120 can display “Staff Picks,” which can be applications that are selected by a curator at the marketplace based on the selected applications being deemed especially interesting to users who visit the marketplace in search of applications.

Within the user interface 100, categories 112, 114, 116, 118, 120 can display a subset of applications that are categorized to fall within the category. Because screen space within the user interface is limited, only a subset of the applications that fall within a category may be displayed within the user interface 100. However, by selecting a hyperlink associated with the category, more applications that fall within the category can be displayed to a user. For example, each category 112, 114, 116, 118, 120 is associated with a hyperlink labeled “All,” the selection of which may cause more applications that fall within the category to be displayed.

Other parts of the user interface 100 also can be used to organize the digital goods that are available in the marketplace. For example, an “Apps” section 122 can provide a list of hyperlinks, which each can be selected to display applications that belong to a category identified by the hyperlink. For example, selection of the “Education” hyperlink 123 can cause a group of icons that represent applications related to educational topics to be displayed. In another example, an “Extensions” section 124 can provide a list of hyperlinks, which each can be selected to display extensions that belong to a category identified by the hyperlink, where an extension is executable code that extends the functionality of a browser. For example, selection of the “Sports” hyperlink 125 can cause a group of icons that represent extensions related to sports topics to be displayed.

In addition to locating digital goods (e.g., Web applications and extensions) that are already displayed within a category 112, 114, 116, 118, 120 of the user interface 100, which could be displayed as a result of selecting a hyperlink 113, 123, 125, digital goods also can be located as a result of a query for goods that may be of interest to the user. For example, a user may enter query terms into an query box 126 that may receive the query terms and pass the terms onto a search engine that then locates digital goods that match the query terms and that are available in the marketplace. For example, digital goods such as web applications can have a variety of metadata associated with them that are used to index the digital goods, and the query terms can be compared to the metadata associated with the digital goods. Based on the comparison, applications that best match the query terms can be selected from the digital goods available in the marketplace, and the selected goods can be presented to the user in the user interface 100.

The user interface 100 also includes a hyperlink 127 that can be selected so that the user can log into the marketplace. For example, selection of the hyperlink 127 can trigger the display of a prompt to the user to enter a username and password, and successful entry of the username and password may allow the user to log into a personal account associated the marketplace. As explained in more detail below, once the user is logged into the marketplace, digital goods can be selected and presented to the user within the user interface 100, where the selection of the goods can be personalized to the user based on data associated with the user's account.

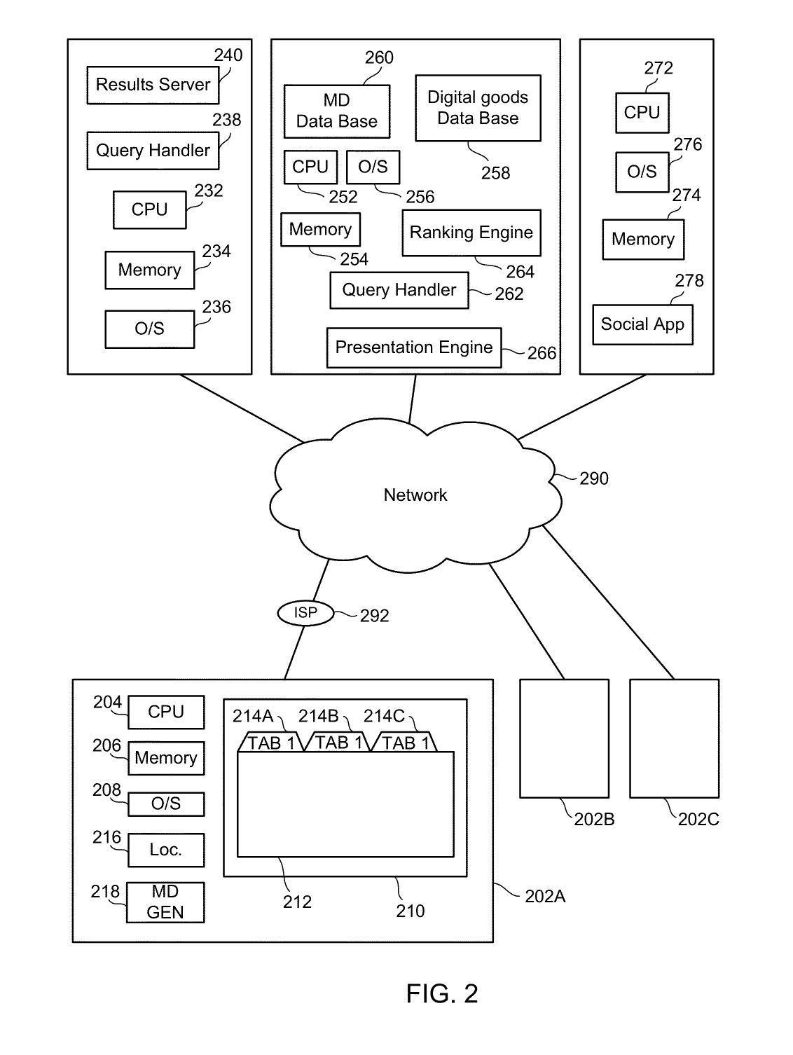

FIG. 2 is a schematic block diagram of an example embodiment of a system 200 for ranking digital goods in a marketplace. In various embodiments, the system 200 may include client computing devices (e.g., desktop computers, notebook computers, netbook computers, tablet computers, smart-phone, etc.) 202A, 202B, 202C. A client computing device 202A can include one or more processors 204 and one or more memories 206. The client computing device 202A can execute an operating system 208 and an application 210 that which may display a user interface window 212. The client computing device 202A can include a location detector 218, which may automatically detect a location of the computing device, for example, based on global positioning system (GPS) signals, or by triangulation of signals from transmitters at known locations, or by using other hardware and/or techniques.

In one embodiment, the client computing device 202A may be running or causing the operating system 208 to execute an application 210 or window 212. For purposes of illustration the window 212 is referred to as a web browser. However, it is understood that the above is merely one illustrative example to which the disclosed subject matter is not limited. In various embodiments, this window 212 may include a plurality of panes or tabs 214A, 214B, 214C. The window 212 can be a visual area, usually rectangular, containing some kind of user interface. In a graphical user interface (GUI) used in the client device 202A, the window 212 can be a two-dimensional object arranged on a plane of the GUI known as the desktop. The window 212 can include other graphical objects, e.g., a menu-bar, toolbars, controls, icons and usually a working area in which the document, image, folder contents or other main object can be displayed. The working area may be capable of holding only one main object (i.e., in a single document interface) or more than one main object in a multiple document interface. In some applications, specifically web browsers, multiple documents can be displayed in individuals tabs 214A, 214B, 214C. These tabs 214A, 214B, 214C are typically displayed one at a time, and are selectable via a tab-bar which often resides above the contents of an individual window. That is, one selected tab 214A is “forward-facing” and displays information or content to a user in the window 212, with the content of other tabs 214B, 214C is “hidden.”

The client computing devices 202A, 202B, 202C may receive online content from one or more server computing devices 230, 250, 270, that may be connected to the client device 202 through a network 290. Each of the client computing devices 202A, 202B, 202C can be connected to the network 290 through a local Internet Service Provider 292. The received online content can be processed and displayed in the window 212 (e.g., in a on a tab 214 of the window 212). For example, the window 212 can display a user interface of a marketplace for digital goods, similar to the user interface of the marketplace described herein, to a user. A user can interact with the displayed content, and an activity metadata generator 218 can monitor the user's interactions with the content and the performance of the application 210 and can generate activity metadata based on the user's interactions with the content and based on the performance of the application 210.

A location of the client computing device 202A can be determined based on a location associated with the ISP 292. For example, a known location of the ISP can be used as an approximation or as a proxy for the location of the client computing device 202A.

The client computing device 202A can communicate with a digital goods marketplace server 250 that provides a marketplace for digital goods to client computing devices 202A, 202B, 202C. The marketplace server 250 can include one or more processors 252 and one or more memories 254. The marketplace server 250 can execute an operating system and various applications and services to provide functionality to the client computing devices. For example, in one implementation, the marketplace server 250 can include a repository for database of digital goods 258, and the digital goods can be served from, or downloaded from, the repository to the client computing devices. In another implementation, the digital goods can be stored in, and served to client computing devices from, a repository that is remotely located from the marketplace server. For example, digital goods could be stored and served to client computing devices from individual repositories that are operated and controlled by developers of the digital goods, and digital goods repository 258 of the marketplace server 250 can provide just a reference to the individual repositories that are operated by the developers.

The marketplace server 250 can include a metadata database 260 that stores metadata associated with the digital goods that are available from or referenced by the digital goods repository 258. The metadata associated with a digital good can include a variety of information about the digital goods including, for example, information about the digital goods that are available from the repository 258. Such information can include, for example, representative keywords associated with the digital goods, the price associated with the digital goods. The metadata may also include demographic data about targeted users of the digital good, a time of year month or day during which the digital goods may be of the highest interest to a user, etc. For example, metadata associated with the surfing videogame may indicate that the good is intended for use by male users between the ages of 15 and 34, who live in coastal California or Hawaii, and that the game may be more popular during summer months than during winter months.

The marketplace server 250 can include query handler 262 that can be configured to receive and process queries for digital goods available in the marketplace. For example, the query handler can receive queries for digital goods that are entered into query box 126 of the user interface 100 shown in FIG. 1. Terms or phrases of the queries then can be compared to terms and phrases (e.g., terms and phrases stored in the metadata database 260) that are used to index the digital goods available in the marketplace. Based on the comparison, a subset of digital goods can be selected from the database 258 with which to respond to the query.

The marketplace server 250 can include a ranking engine 264 that is configured to rank digital goods based on signals relevant to the relative desirability of the goods to a user, where at least one of the signals is based on information that is generated outside the marketplace. For example, the goods can be ranked based on their price in the marketplace, but a signal such as price is generated within the marketplace because the prices are relevant only within the marketplace. However, as described herein, other signals can be generated outside the marketplace and used by the ranking engine to rank the relative desirability of goods to a user.

The marketplace 250 can include a presentation engine 266 that prepares information for transmission to the client computing devices 202A, 202B, 202C, where the information is used by the client computing devices to display a user interface 100 that shows representations of selected digital goods available in the marketplace. For example, based on the output of the ranking engine 264, the presentation engine 266 can prepare HTML code, XML code, etc. that determines the information that is displayed to a user in the user interface 100 and where the code determines which digital goods will be displayed in the user interface 100 to the user.

The ranking engine 264 can use a variety of signals to rank the relative desirability to the user of different digital applications available in the marketplace, where some of the signals can be based on information that is generated outside of the marketplace. In one implementation, the signals used by the ranking engine 264 can be based on how a web application available from the marketplace is used by a client computing device or how a web application performs when utilized by a client computing device.

In one implementation, a signal used by the ranking engine can be based on how often a digital good available from the marketplace is used on a client computing device 202A, 202B, 202C, after the digital good is downloaded from the digital goods repository 258 to the client computing device for execution on the client. For example, when a web application is downloaded from the repository 258 and is executed by a browser application 210 running on the client device 202A, the browser application can monitor each time the web application is launched within the browser and can report this information to the ranking engine 264. The ranking engine 264 then can rank the applications based on how often they are launched by client devices after they are downloaded. For example, an application that is launched frequently can be ranked higher than an application is launched less frequently.

The browser application 210 also can monitor and gather information about how often a user interacts with a web application after the web application has been downloaded from the digital goods database 258 and launched within a browser application 210 of the client computing device 202A. For example, the browser application 210 can provide a window 212 that can include multiple tabs 214A, 214B, 214C, where one tab can be front-facing while other tabs are hidden. The browser application 210 can monitor how often a web application that is launched in the browser is front-facing, as opposed to hidden, and this information can be provided to the ranking engine 264 to provide an indication of how often a user interacts with the web application. The ranking engine 264 then can rank with applications based on how frequently a user interacts with the applications after they are downloaded. For example, an application with which a user interacts frequently can be ranked higher than an application with which a user interacts less frequently.

In another implementation, a signal used by the ranking engine can be based on at least one application performance metric. Examples of such application performance metrics may include: a rate at which a web application available from the marketplace crashes while being executed by a client computing device 202A, 202B, 202C, a response time of a web application while being executed by a client computing device 202A, 202B, 202C, or a system resource (e.g., processor usage, network bandwidth usage, etc.) usage or consumption a web application while being executed by a client computing device 202A, 202B, 202C, etc. It is understood that the above are merely a few illustrative examples to which the disclosed subject matter is not limited.

For example, in one other implementation, a signal used by the ranking engine can be based on a rate at which a web application available from the marketplace crashes while being executed by a client computing device 202A, 202B, 202C. In one implementation, after downloading a digital good from the marketplace server 252 to the client computing device 202A, the digital good can be executed by an application 210, and the application can provide feedback to the marketplace server 250 about the performance of the digital good. For example, a web application can be downloaded from the digital goods database 258 and installed on the client computing device 202A for execution by a browser application 210. Then, the browser application can monitor the performance of the web application, and the frequency with which the web application crashes.

The information that is provided by an application 210 running on a client device to the marketplace server 250 (e.g., regarding how a web application is launched, how often the user interacts with a web application, how often a web application crashes, etc.) can be provided on an opt-in basis. In other words, such information may be provided from the client computing device 202A to the server 250 only if the user of the client device specifically authorizes the transmission of such information from the client to the server.

Because the browser application 210 can communicate easily over the network 290, the browser application can provide feedback to the ranking engine 264 of the marketplace server about the local usage of the web application on the client computing device. By receiving such feedback from many client computing devices 202A, 202B, 202C, the ranking engine 264 can gather a great deal of information about how an application is actually used after it is downloaded from the marketplace server 250. Thus, the ranking engine 264 has the ability to rank digital goods available from the marketplace server 250 based on signals relevant to the relative desirability of different applications to users, where such signals can include signals based on information about how applications are actually used, or how applications actually perform, after the applications are downloaded from the marketplace server 250 and installed on a client computing device. Moreover, by using signals that are automatically generated as the web applications are used, the ranking of the digital goods in the marketplace can be somewhat more objective than rankings based on subjective user reviews based on users' experience with the web application, which users may enter directly into the marketplace server 250 (e.g., by adding metadata information about a digital goods to the metadata database 260).

The above-described signals are but a few examples of signals based on information that is generated outside of the marketplace and that is relevant to the relative desirability to the user of different applications that are available from the marketplace. Other signals also can be used by the ranking engine 264.

In another implementation, signals based on information that is generated outside of the marketplace and that are used by the ranking engine 264 for ranking the relative desirability of digital goods available marketplace can include signals based on information provided by a search engine. For example, in one implementation, such signals can be based on recent trends in query terms received through a search engine.

As shown in FIG. 2, the system 200 can include a search engine server 230 that includes one or more processors 232, one or more memories 234, an operating system 236, a query handler 238, and a result server 240. The query handler 238 can receive queries that include one or more query terms or query phrases from client computing devices 202A, 202B, 202C, and a result server 240 can provide search results in response to the queries. The search engine server 230 can monitor the query terms and phrases received from client devices, and based on the query term traffic the search engine server 230 can generate statistics about trends in users' interests. For example, when a previously-unknown singer becomes a star entertainer, trends in query term traffic may reveal that users are becoming more interested in discovering information about the singer. Similarly, when a movie or a game becomes popular, trends in the search engine traffic received to the search engine server 230 can automatically reveal the increase in the popularity. In another example, search engine trends can be driven by seasonal factors, such as search queries for “costumes” rising in the weeks before Halloween, or queries for the purchase of products rising during the winter holiday season.

Such trends in query term traffic can be provided by the search engine server to the marketplace server 250, so that the ranking engine 264 of the marketplace server can rank digital goods available in the marketplace based on trends in query traffic. For example, the ranking engine 264 can boost or lower the relative ranking of individual digital goods available in the marketplace will 250 based on search engine traffic. Thus, for example, when search engine traffic reveals that a game or a movie is becoming popular, and such information is provided to the ranking engine 264, the ranking engine can boost the ranking of web applications that are related to the game or the movie.

In another implementation, signals based on information that is generated outside of the marketplace and that are used by the ranking engine 264 for ranking the relative desirability of digital goods available marketplace can include signals based on information provided by a social network applications or servers. For example, in one implementation, such signals can be based on how digital goods are used by acquaintances of a particular user, and the rankings performed by the ranking engine 264 can be based on such signals and can be specifically tailored for the particular user.

In another implementation, signals based on information generated inside of, or outside of, the marketplace can be based on how digital goods are used by people with similar preferences to a particular user, and the rankings performed by the ranking engine 264 can be based on such signals and can be specifically tailored for the particular user. For example, different users may tend to like, or present positive quantitative feedback on, different items, such as sports, movies, songs, productivity applications, games, gossip, etc. Users preferences can be determined based on feedback provided by the user regarding, and a particular user's preferences can be compared to the preferences of other users. Then, digital goods can be recommended to the particular user, which have been shown to be desirable to other users with similar preferences. Thus, for example, if a particular indicates that he or she likes sports, then one or more signals used to rank digital goods for that user may be based on what digital goods other users who like sports have selected, or based on the applications that such other user use heavily.

As shown in FIG. 2, the system 200 can include a social network server 270 that includes one or more processors to 272, one or more memories 274, an operating system 276, and a social network application 278. The social network application 272 can provide a network, environment, virtual world through which a particular user can interact with selected colleagues, friends, acquaintances (collectively, “friends”) of the particular user. For example, the particular user can exchange information with his or her friends about interests that they may share. Thus, a user that downloads a digital good from the marketplace server 250 and installs and executes the digital goods within a client computing device controlled by the user may recommend the web application to the user's friends. Such recommendations pass through the social application 278, and anonymous information about such recommendations can be gathered by the social network server 270 and then passed on to the ranking engine 264. The ranking engine then can base its rankings of digital goods in the marketplace on statistical information about such recommendations. For example, the ranking engine 264 can boost the ranking of a web application that has received a large number of recommendations within the context of a social network application 278. In another example, the ranking engine 264 can boost a user-specific ranking of a web application when the web application has been recommended frequently within the context of a social network application by friends of the specific user to their friends.

The ranking engine 264 also can use other signals that are generated outside of the marketplace to generate rankings of digital goods available in the marketplace. In one implementation, the ranking engine 264 can provide rankings specific to a user of digital goods that are available within the marketplace, where the rankings are based in some way on information that is associated with the user and that is generated outside the marketplace. In one implementation, the information associated with the user may include information that the user actively provides or enters (e.g., the user's age, one or more user entered preferences, likes or dislikes, etc.). In one implementation the information associated with a user may include information inferred from user actions (e.g., the user's browsing history, the user clicking on advertisements, etc.) or passively gathered about the user (e.g., the user's location, etc.).

For example, a location associated with the user can be compared to metadata associated with digital goods, and the ranking engine 264 can provide rankings of digital goods based on such comparisons. A location of a user can be determined in a number of ways, including by the location generator 216 or based on a location associated with the ISP 292 through which the user's client device communicates with a network 290. The location of a user can be compared to metadata associated with digital goods so that the relevance of digital goods to the user can be ranked based on the user's location. For example, an application that calculates marine tides generally be of low relevance to a particular user who lives far from the coast, and accordingly should be ranked low for the titular user by the ranking engine. Thus, when information about the user reveals that the user lives or is located in Albuquerque N. Mex., then a marine tide web application that is associated with metadata indicating that the application is relevant to coastal users, would have a relatively low ranking for the user.

In another implementation, information associated with the user can include a browsing history of the user that provides information about content (e.g., websites) that the user has accessed through a browser application 210. Metadata about the accessed content, or the content itself, can be compared to metadata associated with digital goods available in the marketplace. Based on the comparison, the ranking engine 264 can provide rankings of the available digital goods to a user that are individually-tailored to the interests of the user, as determined from the browsing history of the user. For example, if the browsing history reveals that the particular user is primarily interested in playing computer or video games, then the ranking engine can boost the user-specific rankings of game applications that are available in the marketplace.

The information that is provided by an application 210 running on a client device to the marketplace server 250 (e.g., regarding a user's browsing history, etc.) can be provided on an opt-in basis. In other words, such information may be provided from the client computing device 202A to the server 250 only if the user of the client device specifically authorizes the transmission of such information from the client to the server.

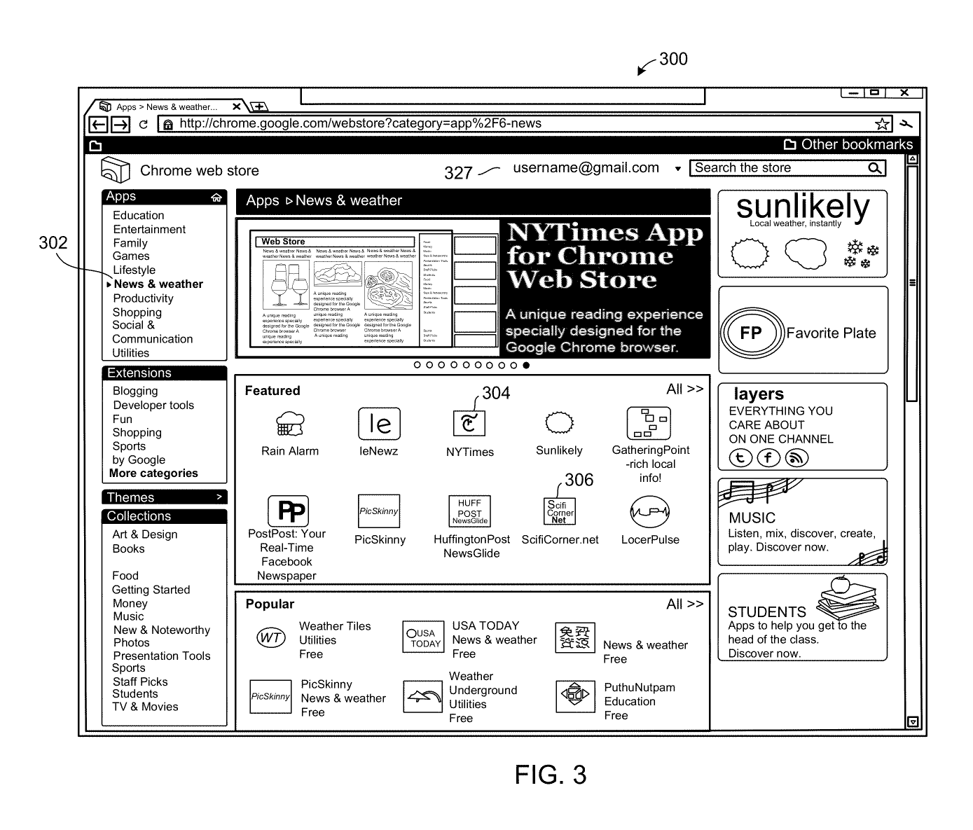

FIG. 3 is a screenshot of the user interface 300 to a marketplace of digital goods. The presence of a username 327 in place of the hyperlink 127 that is selectable so that the user can enter login credentials indicate that a user has logged in to an account associated with the marketplace that is presented by the marketplace server 250. The account associated with the marketplace also can be associated with other online or local services or applications the user may use. For example, the account associated with the marketplace also can be associated with the user's online e-mail account (e.g., Microsoft Hotmail, Yahoo mail, Google Gmail, etc.) the user's online social network account (e.g. Facebook, twitter, etc.), the user's online photo account (e.g., Snapfish, Shutterfly, Picasa, etc.), accounts at content websites (e.g., news websites game websites, entertainment websites, etc.), etc. By associating the user's marketplace account with other accounts of the user, information from the other accounts can be utilized, with the permission of the user, by the ranking engine 264 to provide user-specific rankings of digital goods available in the marketplace to the user. For example, selection of the “news and weather” hyperlink 302 can trigger the display of featured in popular web applications related to news and weather within the user interface 300.

The applications that have been selected for display in the user interface 300, and the position and order in which the selected applications are presented in the user interface, can be based on rankings of the applications provided by the ranking engine 264. For example, if the user has registered and opened an account with the website of the New York Times and that account is associated with the user's marketplace account 327, then the ranking engine 264 may boost the ranking of a web application 304 that is associated with the New York Times. If that user has not registered and opened an account with the Wall Street Journal, or if a user account with the Wall Street Journal is not associated with the user's marketplace account, then the ranking engine may boost the ranking of a web application associated with the New York Times 304 above the ranking of a web application associated with the Wall Street Journal for that particular user. Then, the web application associated with the New York Times 304 may be selected for display in the user interface 300 over a web application associated with the Wall Street Journal.

In another implementation, the ranking engine 264 may select an application 306 that provides news about science fiction related topics for display in the user interface 300 based on signals that are generated outside of the marketplace. For example, if the user's social network friends have downloaded and installed a web application related to science fiction news 306, the ranking engine 264 may boost the ranking of the web application 306. In another example, if the user's browsing history indicates that the user is interested in science fiction related information, the ranking engine 264 may boost the ranking of the web application 306.

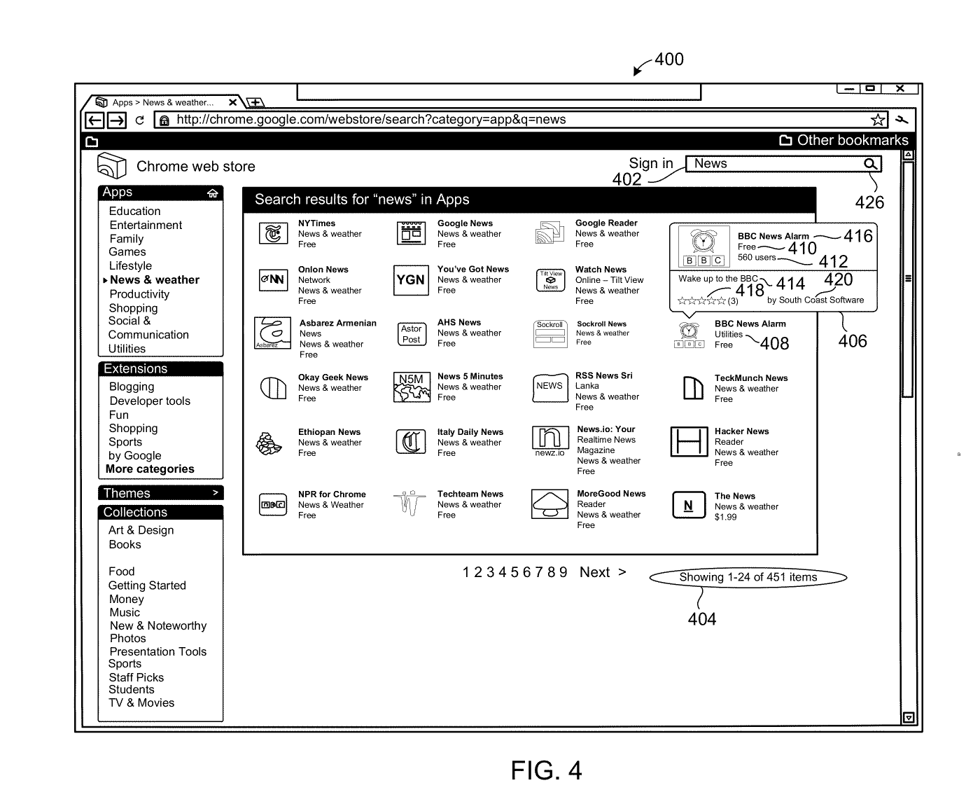

FIG. 4 is a screenshot of the user interface 400 to a marketplace of digital goods. The screenshot is representative of a user interface that can be displayed when a user enters a query term “news” in query box 426 to search for web applications available in the marketplace that are related to news. The query term can be compared to metadata associated with digital goods, for example, metadata stored in metadata database 260. Based on the comparison, the query handler 262 can identify one or more digital goods that are related to the query term. The user interface 400 includes a display item 404 that indicates that a total of 451 web applications have been identified in the marketplace as relevant to the query term “news” and that 24 of the identified applications have been selected for display in the interface 400. The applications that are selected for display in the user interface can be selected based on a ranking of the relative desirability of the identified applications. Furthermore, among the selected subset of applications, the position of the applications within the user interface 400 can be determined by their ranking. For example, applications with higher rankings can be displayed in rows at the top of the user interface 400, and, within a row, applications with a higher ranking can be displayed on the left side of the row.

A pop-up HTML window 406 can be displayed when a user moves a mouse icon over an icon for an application 408 that is displayed in the user interface 400. Within the pop-up HTML window 406, additional information about the web application 408 can be displayed. For example a field 410 can indicate whether the application is free or the price that must be paid to be able to download and install the app. Another field 412 can indicate how many users have downloaded and/or installed and/or used the application. Information about the installation and/or use of the application on a client device can be transmitted from a browser executing the application of the client device to the marketplace server 250. Another field 414 can display descriptive information about the web application that supplements information in the title field 416. Another field 418 can display an average subjective rating that users have provided of the web application and a number of users that have rated the application. Another field 420 can display the name of the author or developer of the application.

The rankings can be determined based on a number of factors or signals, which may include signals that are generated within the marketplace and outside of the marketplace. For example, signals generated within the marketplace can include a relevance of a web application to the query term(s) 402 that are entered in the query box 426 (e.g., as determined by the query handler 262), user feedback of the web applications entered into the marketplace (e.g., by the user's providing comments on the web application or by ranking the application based on a 1-5 star system), or by the number of times an application has been downloaded from the marketplace.

For example, signals generated outside of the marketplace can include the number of times a web application has been launched by an application (e.g., a browser application) running on a client to which the application has been downloaded, the number of times a web application is crashed after it has been downloaded to a client device, how often an application is used after it is downloaded to a client device, how often an application is front facing after being launched by an application running on a client device to which the application has been downloaded, etc. In the example shown in FIG. 4, the NYTimes web application may be the highest ranked application of the 451 items that are responsive to the “news” query entered in the query box 426 and therefore can be displayed in the user interface in the top left corner of the interface. Other applications that are less highly ranked in the NYTimes application may be displayed elsewhere in the user interface or may not be displayed in the first group of 24 applications that are displayed in the interface shown in FIG. 4.

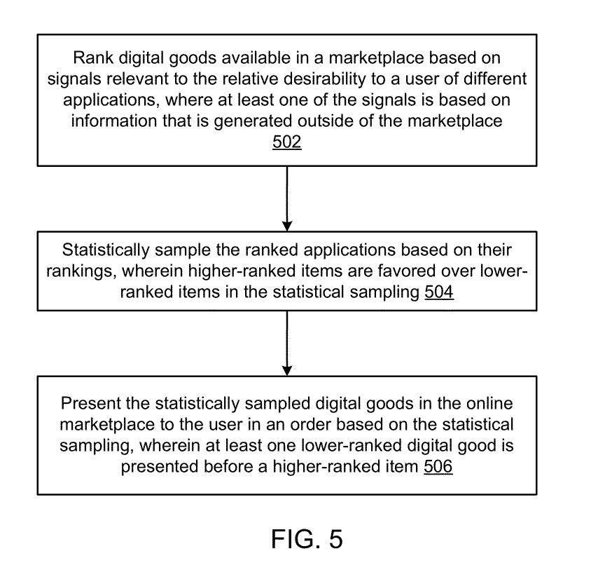

FIG. 5 is a flowchart of a process for presenting to a user a subset of digital goods that may be executed by a computing device, where the subset of digital goods is selected from a plurality of goods available in online marketplace for such goods. The flowchart shown in FIG. 5 can be performed at least in part by a marketplace server (e.g., the server 200 shown in FIG. 2). As shown in FIG. 5, the digital goods can be ranked (e.g., by the ranking engine 264) based on signals relevant to the relative desirability to the user of different applications, where at least one of the signals is based on information that is generated outside of the marketplace (502). The digital goods are statistically sampled based on their rankings, wherein higher-ranked items are favored over lower-ranked items in the statistical sampling (504). For example, the ranking engine 264 can select the subset of digital goods from the digital goods database 258 in the marketplace server 250. The statistically sampled digital goods are presented in the online marketplace to the user in an order based on the statistical sampling, where at least one lower-ranked item is presented before a higher-ranked item (506). For example, the presentation manager 266 can present the digital goods to a client device, so that the client device can process the presented digital goods and display them within a display window 212 on a client device.

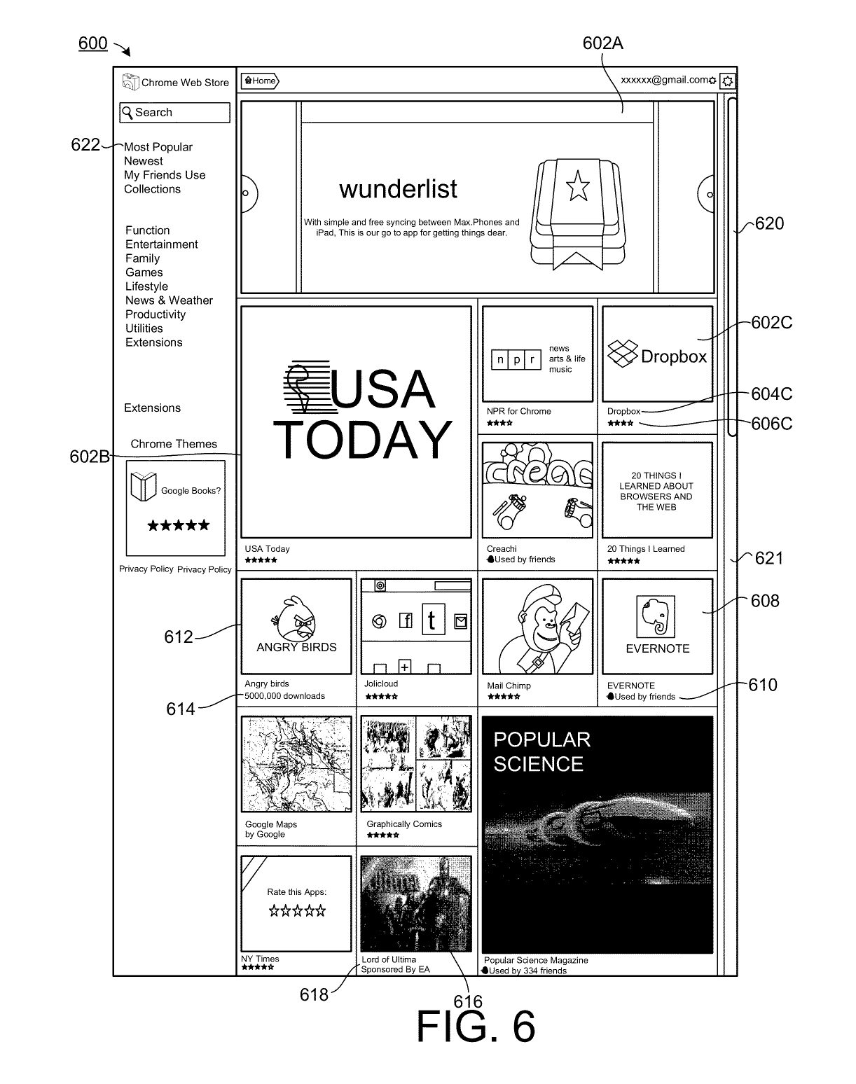

FIG. 6 is a screenshot of another user interface 600 to a marketplace of digital goods that may be used in another implementation. The user interface 600 can be displayed by a browser application that is executed by a computing device that may be connected to a network (e.g., the Internet). The browser application can open one or more tabs, one of which may display the user interface to the marketplace when a user navigates to a webpage identified by a URL that provides content to the browser, so that the browser can display the user interface to the marketplace.

The content provided by the webpage to the user in the user interface 600 can include a plurality of icons 602A, 602B, 602C that represent digital goods (e.g., web applications and extensions) that can be downloaded from the webpage by the user for execution by a computing device controlled by the user. The icons 602A, 602B, 602C also can represent digital goods that can be served by a server to a client for execution by the client (e.g., hosted applications). In contrast to the icons 106A-F, 108A-E, and 110A-C shown in the context of FIG. 1, the icons 602A-C generally provide a richer graphical impression to the user of the web applications and extensions that correspond to the icons 602A-C. For example, the icons 602A-C can include a rich image file that provides a visual impression of the underlying web application or extension to the user in the user interface 600.

The icons can be displayed in different sizes. For example icons 602A is a large rectangle. Icon is 602B is a medium-size square. Icon 602C is a small rectangle. The size of the icon can be used to indicate a quality of the web application or extension that is represented by the icon. For example, items represented by large rectangular icons can be deemed to be of particular significance to a user, for example based on their popularity (as measured by the number of times the item is downloaded from the marketplace), rating (as indicated by the average number of stars the item received in reviews from users), the number of installations of the item by social network friends of the user, an amount of money paid by an advertiser or developer of the item, etc.

In addition to being associated with an image file, an icon can be associated with other information when displayed in the user interface 600. For example, icon 602C can be associated with a textual title 604C that describes the item represented by the icon. The icon 602C can be associated with a subjective rating 606C of the item that is represented by the icon. For example, the subjective rating 606C can be represented by a number of stars that the item receives by users of the item, where a greater number of stars indicates a higher rating for the item. An icon 608 may be associated with an indication of the number of social network friends of a user who have been identified as associated with the item represented by the icon, for example, due to the item having been downloaded, installed, used, reviewed, linked to, associated with (e.g., by the user providing a “thumbs-up” or “+1” badge to the item), etc. by friends of the user. An icon 612 can be associated with a popularity metric 614 of the item that is represented by the icon. For example, the popularity metric 614 can indicate the number of times that the item has been downloaded, installed, launched, etc. by visitors to the marketplace. An icon 616 may be associated with an indication 618 of the identity of a developer or publisher of the item represented by the icon 616. For example, the indication 618 can provide the name of the developer of the item represented by the icon 616.

The user interface can include a slider 620 that the user may select and move to scroll through a plurality of icons that can be displayed in the user interface 600. In this manner, the icons that may be available in the marketplace may be displayed in an “infinite wall” of icons, in which new icons are populated in the user interface 600 as the slider 620 is moved downward. In one implementation, the slider 620 can be moved up or down along a vertical bar 621 along the right side of the user interface 600 populate the user interface 600 with different icons. For example, by moving the slider 620 downward along the bar 621 icons currently displayed in the user interface 600 may be moved upward until they disappear beyond a top hedge of the user interface 600, and new icons may appear in the interface from below the bottom edge of the user interface 600.

For example, the presentation engine 266 can provide particular items to the user interface 100, 600 for display based on a position of the slider 620 along the slider bar 621. In some implementations, when the slider 620 is moved by the user to the bottom of the vertical bar 621, new icons can be populated in the user interface 600 from below the bottom of the edge of the user interface until the slider 620 reaches the bottom of the vertical bar 621. Then, when the slider 620 is placed by the user at the bottom of the bar 621, the slider may be automatically moved (without user input) upward along the bar 621, so that it is positioned between the top of the bar in the bottom of the bar and therefore can be moved vertically again by the user to control the display of traditional icons in the user interface 600. In some implementations, the icons can be pre-fetched from the marketplace provided by the server 250 for display in the user interface 100, 600. For example, icons can be pre-fetched from the digital goods database 258, downloaded to the client device 202A, and stored within local memory 206, so that the downloaded icons will be ready to be displayed within the interface 100, 600 as the user scrolls the slider 620 down along the vertical bar 621 of the user interface 600. Five prefetching the icons and having them available within local memory 206, a smoother scrolling experience may be provided to the user.

The infinite wall may be contrasted with providing a fixed number of icons in discrete pages of the user interface 400 shown in FIG. 4, where the individual pages may be displayed based on a user selection of a hyperlinked numeral below a pane of icons, where selection of the hyperlinked numeral will trigger the display of a discrete page of icons. The infinite wall of icons along with the slider bar 620 may provide a user of the marketplace user interface 600 with a more seamless experience when the user interacts with the interface 600 to explore the marketplace and discover new items in the marketplace.

Within the user interface 100 or 600, when there are many items that satisfy the criteria for display within the user interface, only a subset of the total number of items satisfying the criteria can be selected for displayed within the interface at any one time to the user. Individual items can be selected from the total number of items for display in the user interface 100 or 600 based on statistical factors, as described more fully herein. Although this description refers sometimes to the display of items in the user interface 100 or 600, in fact this nomenclature is only a shorthand for describing the display in the user interface of icons that correspond to items (e.g., web applications and extensions).

The statistical factors governing the selection of individual items for display in a user interface of the marketplace can be chosen to display items that are highly relevant to a user near the top of the infinite wall in user interface 600, or on the first page, or one of the first few pages, of the user interface 100. However, the statistical factors also can be chosen to ensure that items that generally are not predicted to be highly relevant or interesting to a user nevertheless are shuffled into the user interface, so that the user has the opportunity to discover such items in the marketplace. The selection of lower-ranked items to shuffle in may give preference to relatively new items, or recently updated items.

For example, when a user desires to view popular items in the user interface 600, the user may select a hyperlink 622 to call up popular items for display in the interface. The popularity ranking of items can be determined based on metadata stored in database 260 and associated with the items. However, instead of displaying items in the interface 600 in exact order of their popularity rank, items with high popularity rank may be favored for display at the top of the infinite wall user interface 600, although items with low popularity ranks may have a small but non-zero chance of being displayed at the top of the infinite wall user interface. In this manner, the user generally is provided with what he or she expects to see—i.e., a large number of popular items at the top of the user interface 600—while some obscure items are also sprinkled into the items that are displayed to the user. Therefore, the user has the opportunity to discover obscure items that he or she otherwise would not see, and developers of the obscure items have the ability to get their applications and extensions in front of users, so that users will have the opportunity to, download, and install the obscure items. The selection of obscure items may be based on the age of an item, such that obscure items that have been added relatively recently are preferred.

By providing occasional exposure to the long tail of obscure items within prominent parts of the user interface 600, those items are given the opportunity to make an impression on users. The response of users to those items can be monitored, and the popularity rank of the items can be adjusted based on the users' responses. For example, an item's popularity rank can be increased when the item is downloaded, installed, launched after has it has been presented to the user in the user interface.

In some implementations, a trending stream can be used to measure trends in an item's popularity in the marketplace. The treading stream can account for an item's popularity not only based on the total number of times the item has been downloaded from the marketplace, installed on the client, launched by the user, etc., but also based on a rate at which an item is downloaded, installed, launched, etc. per the number of times the item is presented to users in the user interface 600. Therefore, if a first (obscure) item is presented in the user interface 600 relatively infrequently but is downloaded relatively often when it is presented, that first item may have its rank in the trending stream boosted by a greater amount than a second (well known) item that is that is downloaded often from the user interface but which is downloaded relatively infrequently per the number of times that it is presented. For example, using a hypothetical numbers, there may be 4000 items in the marketplace, and the first item may be ranked 3497^{th} in terms of popularity, and may have been downloaded a total number of 234 times, but the first item may have been downloaded one out of every 10 times that it was presented in the user interface in the last month. The second item may be ranked fifth in terms of popularity and may have been downloaded a total number of 1,478,276 times but the second item may have been downloaded one out of every 200 times that it was presented in the user interface in the last month. Using these example hypothetical numbers, based on the number of times the items are downloaded per the number of times they are presented within the user interface, the popularity rank of the first item may be boosted by a larger amount than the popularity rank of the second item.

In another implementation, the probability of displaying an item at a particular position within the infinite wall user interface 600, or on a particular page of interface 100, can be determined by more than one factor. For example, when a user desires to view popular items, for example, by selecting a hyperlink 622, the probability of displaying an item and a particular position within the interface 600 can be determined not only by the items popularity rank but also on a factor involving the age of the item in the marketplace or the time since the item was last updated. Then, using a combination of the popularity and age factors, newer items (which may have relatively low popularity rankings because they have not existed in the marketplace for a long time) may be promoted to higher positions within the user interface. Similarly, an item that performs well, for example, based on performance-based metrics can be promoted to higher positions within the user interface 600, even if their popularity rankings are relatively low.

In still another implementation, a main wall of the user interface 600 may include icons for items selected from all of the items that are available within the marketplace. For example, when a user first navigates to the webpage that provides a marketplace, the user interface 600 can display icons for items selected from all of the available items within the marketplace. The order in which items are displayed in the main wall of the user interface 600 can be determined by a number of factors, as explained in more detail herein.

Different criteria associated with items can be used to determine the items to display in the user interface 100 or 600 and the order in which to display the items within the interface. The different criteria can be used to rank order a list of items in a “stream” of items. Some streams may contain all of the items that are available in the marketplace. For example, a stream of items based on a popularity ranking may include all the items in the marketplace starting with the most popular item and ending with the least popular item. Other streams may include fewer than all of the items in the marketplace. For example, a stream of items ordered by the number of associations with social media friends of the user may include fewer than all of the items in the marketplace if the stream does not include items that have zero associations with social media friends of the user. Other examples of streams can include a stream of manually curated items, a stream of advertised items, a stream of items ranked by their deposit time/date in the marketplace, and a stream of items that are associated with social media friends of a user. Streams can be defined based on one or more signals generated outside of the online marketplace, as described above (e.g., the number of times an application is installed or launched after it is downloaded or otherwise associated with a user). Manually curated items can be items that a curator of the marketplace has deemed to be noteworthy for some reason and which received a ranking within the manually curated stream by the curator. Advertised items can be items for which money has been paid to the proprietor of the marketplace to advertise the items through prominent placement within the marketplace, and such items can be ranked within the advertised items stream according to how much has been paid to advertise the item. The amounts paid to advertise the item can be based on a variety of factors. For example, an advertiser may pay an amount determined by one or more of the following factors: the number of times the item is displayed in the marketplace to a user; the number of times the item is downloaded from the marketplace by a user; the number of times an item is selected (e.g., “clicked”) in the marketplace by a user; the number of times the item is installed or launched by a user, etc. The stream of items associated with social media friends of the user can be ranked by the number of associations that they have with social media friends of the user.

Items can be pulled from multiple different streams for display in a single user interface 100, 600. For example, items can be selected from a stream of items ranked by popularity and a stream of items ranked by the age of the items in the marketplace for display in the user interface. When items are pulled from multiple different streams, the streams can be combined by assigning a weight to each stream to determine the proportion of items that should be selected from each of the different streams. For example, if the popularity stream had a weight of 0.8 and the age stream has a weight of 0.2, then four times as many items may be selected from the popularity stream as from the age stream for display in the user interface. In a particular implementation, items can be pulled from a plurality of different streams for display in the main wall (i.e., the page that displays items selected from the set of all items available in the marketplace). The items selected for display in the main wall can be selected based on weights assigned to each of a plurality of different streams. For example, items selected for display in the main wall can be pulled from a plurality of different streams in proportion to weights assigned to the different streams.

In addition, a shuffling algorithm can be applied by the ranking engine 264 or the presentation engine 266 to the selection of items from individual streams, so that the user receives a dynamic impression of the items presented in the user interface. In other words, because of the dynamic display of items in the user interface, the user may be surprised by the display of some previously unseen items in the user interface, even when the user applies the same selection criteria for the display of items. In addition, the shuffling algorithm can be used to expose the “long tail” of items that would usually rank low within a stream or within the user's selection criteria. The shuffling algorithm generally favors items that are ranked higher in the stream(s) but also allows a small number of items buried deep within the low rankings of stream(s) occasionally to show up in prominent places within the user interface.

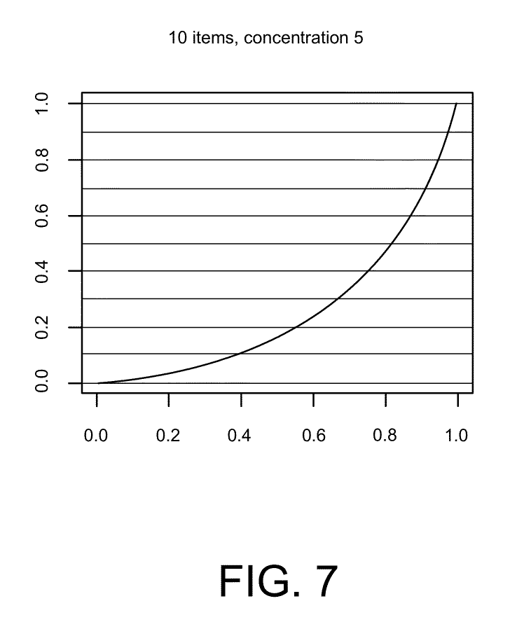

In one implementation, the probability of selecting an item from a stream can be based on a monotonically decreasing positive function, ƒ. The probability that the i^{th} item from a stream is selected for display in the user interface 100, 600 can be proportional to ƒ(i, λ), where i is the ranking of the item in the ranked list of items of the stream and where the value of λ determines how flat the probability distribution is. FIG. 7 is a plot of an example function that may be used to select items from a ranked list according to a probability that depends on the function. The higher-ranked items are selected with higher probabilities, and the long-tail, lower-ranked items are selected with smaller probabilities. In one particular, non-limiting example, items from a stream can be sampled using a probability distribution based on a Gaussian equation, ƒ, where the equation is given by:

$$f = f ( i , N , λ ) = A {e}^{- {( \frac{i}{\sqrt{2} N λ} )}^{2}}$$

where N is the number of items in the stream, i is ranking the item in the stream, and λ is a fixed parameter, and A is a normalization constant. After an item is selected, the value of λ may be changed, e.g. to provide a flatter probability distribution among the items in the stream for subsequent selection steps. In some implementations, the sampling of lower-ranked items can preferentially sample items that have been added more recently to the marketplace.

In another implementation, items in a stream can be sampled using a transformation of uniform random numbers. An increasing and concave continuous function, g, can be defined, with g(0)=0 and g(1)=1. One example of such a function is shown in FIG. 7. A uniform random number, u, between 0 and 1 can be generated, and y=g(u) can be calculated. Then an item can be selected from the ranked list of items in the stream according to the truncation function, trunc(N*y), where N is the number of candidate items in the list and trunc indicates truncation to the next lowest integer value.

For example, as shown in FIG. 7, if there are 10 items in a ranked list, then when the value of y is less than 0.1 the first item in the list would be selected. When the value of y is between 0.1 and 0.2, then the second item in the list would be selected, and so on. Using the transformation to select items from a ranked list, as described herein, is computationally efficient, because it is not necessary to explicitly compute probabilities for each item in the list. Therefore, selecting items from the ranked list can be quite fast.

The function g can depend on a parameter λ according to the relationship, y=g(u,λ), where λ determines the degree to which top-ranked items are favored. For the curve shown in FIG. 7, the slope of the curve at zero is ⅕, so top-ranked items are selected about five times as often; the slope at one is 5, so low-ranking items are selected ⅕ as often.

In one implementation, items from a stream can be sampled using a probability distribution based on a parametric equation, ƒ, where the equation is given by:

$$f = f ( t , λ ) = \frac{{e}^{t \cdot λ} - 1}{{e}^{λ} - 1} ,$$

where t is a variable and λ is a fixed parameter. The x,y coordinates of a curve can be given by:

x=ƒ(t,−λ)

y=ƒ(t,λ).

Then, the curve provided by the x and y coordinates has a slope at x=0 of e^{-λ} and a slope at x=1 of e^{λ}. The parameter, λ, can be used to determine the degree to which high-ranking items in a stream are oversampled compared to low ranking items in the stream. For example, high values of λ will tend to favor high-ranking items compared to low values of λ.

To use the parametric equation to statistically sample items from a ranked list of N items, a random number between zero and one can be generated. The random number can be used as the variable, t, and the value of the function, y, can be used to select an item from the ranked list as follows. When the value of y is less than 1/N, then the first (highest-ranking) item on the list is selected. When the value of y is greater than 1/N and less than 1/(N−1), then the second highest-ranking item on the list is selected. When the value of y is greater than 1/(N−1) and less than 1/(N−2), then the third highest-ranking item on the list is selected, and so on. For example, as shown in FIG. 7, if there are 10 items in a ranked list, then when the value of y is less than 0.1 the first item in the list would be selected. When the value of y is between 0.1 and 0.2, then the second item in the list would be selected, and so on. Using the parametric equation to select items from a ranked list, as described herein, is computationally efficient, because it is not necessary to explicitly compute probabilities for each item in the list. Therefore, selecting items from the ranked list can be quite fast.

After an item has been selected from the ranked list, the item can be removed from the possible items that can be selected for display in the user interface. This ensures that items will not be displayed more than once in the user interface, so that the user does not see the same item displayed in different positions within the user interface 100, 600.

In some implementations, a new random number does not need to be generated each time another item from the ranked list of items is selected. Rather, a random number can be generated initially and used to select an item from the ranked list, and then that random number can be used as a seed with which to generate other values of the variable, u, for the selection of additional items. For example, if the initial random number is represented by RND, then the value of u that is used to perform the i^{th} selection of an item from the list can be given by uᵢ=RND+i*β, mod 1, where β is a fixed irrational number. In one implementation, the fixed value, β, can be the golden ratio, which is approximated by 1.61803398874989. Then, the sequence of values given by the successive values of uᵢ form a quasi-random sequence (also known as the low-discrepancy sequence) of values that are more evenly spaced than a series of random numbers would be. This quasi-random sequence discourages selection of a single item more than once from the ranked list of items in the stream. Because of this, after a particular item has been selected for display in the user interface 100, 600 and when the number of selected items is relatively small compared to the total number of items in the ranked list, it may be unnecessary to remove that particular item from the possible items that can be selected subsequently for display in the user interface. This is advantageous, because then maintaining the list of items is simpler, because the number and ranking of items in the list does not have to be updated as items are removed from the list, until very many items have been removed from the list, at which point many items may be removed from the list at once. This may be advantageous, because using low-discrepancy sequences can ensure that multiple low-ranked items are not selected together.

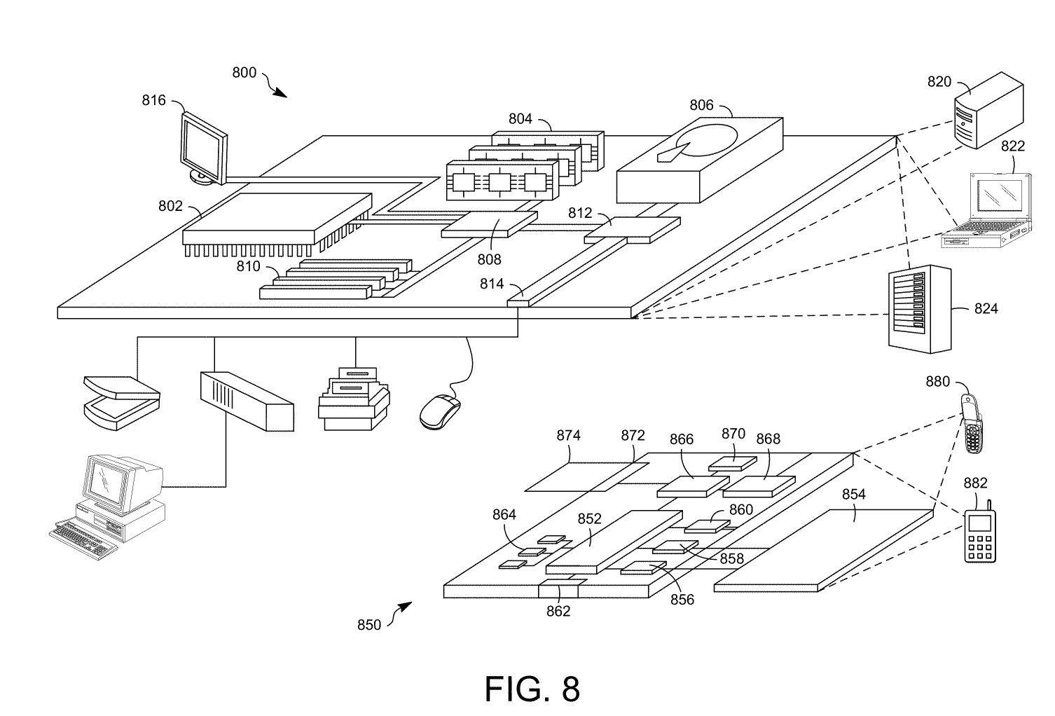

FIG. 8 shows an example of a generic computer device 800 and a generic mobile computer device 850, which may be used with the techniques described here. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 86. The low-speed expansion port, which may include various communication ports (e.g., USB) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a BLUETOOTH, WiFi, or other such transceiver (not shown). In addition, GPS (Global Positioning System) receiver module 860 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made to the implementations described herein.

In addition, the logic flows depicted in the figures do not require the particular order shown, or sequential order. In addition, other steps may be provided, or steps may be eliminated, from the described flows, and other components may be added to, or removed from, the described systems. Accordingly, other implementations are within the scope of the following claims.

1. A method of presenting to a user a subset of digital goods that may be executed by a computing device, the subset of applications being selected from a plurality of digital goods available in an online marketplace for such digital goods, the method comprising:
ranking the digital goods based on at least one signal;
statistically sampling the ranked digital goods based on their rankings, wherein higher-ranked digital goods are favored over lower-ranked digital goods in the statistical sampling; and
presenting the statistically sampled digital goods in the online marketplace to the user in an order based on the statistical sampling, wherein at least one lower-ranked digital good is presented before a higher-ranked digital good.

2. The method of claim 1, wherein statistically sampling the ranked digital goods includes selecting digital goods from the ranked digital goods based on a probability function that changes monotonically between a first endpoint and a second endpoint.

3. The method of claim 1, further comprising:
ranking the digital goods based on a plurality of different signals, each of the different signals defining a different ranking stream;
assigning a weight to each ranking stream;
selecting digital goods from the different ranking streams for presentation in the online marketplace to the user in proportion to the number weights of the ranking streams; and
statistically sampling the ranked digital goods in the different ranking streams based on the rankings of the digital goods in the stream, wherein higher-ranked digital goods are favored over lower-ranked digital goods in the statistical sampling.

4. The method of claim 1, wherein the subset of digital goods includes downloadable executable code.

5. The method of claim 1, wherein the subset of digital goods includes web applications that are installable for use in a web browser.

6. The method of claim 5, wherein the at least one signal includes a signal that is based on a response time of the web application while being executed by a computing device.

7. The method of claim 1, wherein the at least one signal includes a signal that is based on information received from one or more browsers that previously executed the digital good.

8. The method of claim 1, wherein the at least one signal includes a signal that is based on at least one digital good performance metric.

9. The method of claim 8, wherein the digital good performance metric is based on a rate at which the digital good crashes while being executed by a computing device.

10. The method of claim 9, wherein the digital good performance metric based on a rate at which the digital good crashes is determined based on information received from browsers that executed the digital good.

11. The method of claim 1, wherein the at least one signal includes a signal that is based on how often a digital good is used after it is downloaded from the marketplace.

12. The method of claim 11, further comprising:
receiving information from a plurality of client devices about how often the digital good is front-facing within a user interface of the client device for executing the digital good; and
generating the signal that is based on how often a digital good is used after it is downloaded from the marketplace based on the received information.

13. The method of claim 11, further comprising:
receiving information from a plurality of client devices about how often the digital good is launched within a user interface of the client device for executing the digital good; and
generating the signal that is based on how often a digital good is used after it is downloaded from the marketplace based on the received information.

14. The method of claim 11, further comprising receiving information from a plurality of client devices about how often the digital good is open within a user interface of the client device for executing the digital good; and
generating the signal that is based on how often a digital good is used after it is downloaded from the marketplace on the received information.

15. The method of claim 1, wherein the at least one signal includes a signal that is based on recent trends in query terms, related searches, and results received through a search engine.

16. The method of claim 1, wherein the at least one signal includes a signal that is based on how often a digital good is recommended by a user of the digital good to acquaintances in social networks of the user.

17. The method of claim 1, wherein the ranking of the digital goods is specific to a user, and wherein the at least one signal includes a signal that is based on how often a digital good is used by acquaintances in social networks of the user.

18. The method of claim 1, wherein the ranking of the digital goods is specific to a particular user, and wherein the at least one signal includes a signal that is based on how digital goods are used by other users with similar preferences to the particular user.

19. The method of claim 1, wherein the ranking of the digital goods is specific to a user, and wherein the method further comprises:
associating metadata with digital goods of the plurality of digital goods;
comparing the metadata associated with digital goods with information associated with the user; and
ranking the digital goods based on the comparisons.

20. The method of claim 19, wherein the information associated with the user includes information generated by the user, including information actively provided by a user and information inferred from user actions.

21. A tangible computer-readable storage medium having recorded and stored thereon instructions that, when executed by one or more processors of a computer system cause the computer system to:
present to a user a subset of digital goods that may be executed by a computing device, the subset of applications being selected from a plurality of digital goods available in an online marketplace for such digital goods;
rank the digital goods based on at least one signal;
statistically sample the ranked digital goods based on their rankings, wherein higher-ranked digital goods are favored over lower-ranked digital goods in the statistical sampling; and
present the statistically sampled digital goods in the online marketplace to the user in an order based on the statistical sampling, wherein at least one lower-ranked digital good is presented before a higher-ranked digital good.

22. A system presenting to a user a subset of digital goods that may be executed by a computing device, the subset of applications being selected from a plurality of digital goods available in an online marketplace for such digital goods, the system comprising:
one or more memory devices arranged and configured to store executable code; and
one or more processors operably coupled to the one or more memory devices, the processors being arranged and configured to execute the code such that the apparatus performs the actions of:
ranking the digital goods based on at least one signal;
statistically sampling the ranked digital goods based on their rankings, wherein higher-ranked digital goods are favored over lower-ranked digital goods in the statistical sampling; and
presenting the statistically sampled digital goods in the online marketplace to the user in an order based on the statistical sampling, wherein at least one lower-ranked digital good is presented before a higher-ranked digital good.
